(19) United States
(12) Patent Application Publication
(10) Pub. No.: US 2009/0132924 A1
(43) Pub. Date: May 21, 2009

(54) SYSTEM AND METHOD TO CREATE HIGHLIGHT PORTIONS OF MEDIA CONTENT

(76) Inventors: Yojak Harshad Vasa, Cary, NC (US); Gary Cole, Cary, NC (US); Charles Liu, Chapel Hill, NC (US); L. Scott Bloebaum, Cary, NC (US); Anthony J. Sammarco, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/944,721

(22) Filed: Nov. 26, 2007

Related U.S. Application Data
(60) Provisional application No. 60/988,206, filed on Nov. 15, 2007.

(51) Int. Cl. G11B 27/031

(52) U.S. Cl. 715/723

(57) ABSTRACT

To improve the consumer experience with electronic devices, a system and method is provided for customizing media content, and particularly video content, by creating highlight portions of the video content. In exemplary embodiments, the video files are “marked” or “flagged” about the portions of the video content to segment the highlight portions within the media file. The marks or flags may be inputted and incorporated as part of the metadata associated with the video file. A user's electronic device may then extract the marks or flags from the metadata, which causes a media player on the portable electronic device to play only the marked highlight portions. In addition, a user may share the highlights with others by transmitting the marked video files to others' electronic devices. Alternatively, the highlight creator may transmit only the metadata to another's electronic device, and the metadata marks may be extracted and applied to a video file stored on the other's device or streamed thereto.

### RELATED APPLICATION DATA

This application claims the benefit of U.S. Provisional Application No. 60/988,206 filed Nov. 15, 2007, which is incorporated by reference as if fully rewritten herein.

### TECHNICAL FIELD OF THE INVENTION

The technology of the present disclosure relates generally to portable electronic devices, and more particularly to a portable electronic device that uses metadata to create concatenated highlight portions of media content.

### DESCRIPTION OF THE RELATED ART

Portable electronic devices commonly have the capability to play media content, such as video and music. Particularly as to video, at times one may not wish to view an entire program or video file, preferring instead a condensed format. For example, viewers often watch highlights of sporting events, movie trailers, excerpts of television programs and movie scenes, particular newscast events, and so on. Such content may be viewed on televisions, computers, mobile telephones and other portable electronic devices, and other media devices. Viewers also at times may desire to skip portions of a video, such as advertisements or uninteresting segments of program content. Broadcasters may provide such partial programming, but it would be entertaining and enjoyable for users of portable electronic devices to be able to create and share customized partial video content, such as highlights of larger programming. There currently appears to be no convenient method for users of portable electronic devices to do so.

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera, an Internet browser for accessing news and information, an audiovisual media player, a messaging device (text, audio, and/or visual messages), a gaming device, a personal organizer, and have other functions as well.

With regard to video player functionality, a user may download video files over the Internet or other communications network and store the downloaded files within memory in the device. Video files also may be streamed to the device, either from a recorded source or from a live broadcast or feed.

Regardless of how a video file is received in an electronic device, the video file typically contains associated “metadata” information. Generally, metadata may be thought of as digital data providing information about other digital data or files. For example, when one takes a picture with a digital camera, metadata associated with the picture file may include such information as the date and time the picture was taken, the file size, an identifier (such as a title, file name, or number), and/or other items of information about the picture. Document files, music files, emails, and other file types similarly may contain metadata that provides information about the associated files. The metadata may be contained within XML descriptive fields within the file.

Like other digital data files, digital video files typically contain metadata information about the video file. For example, the metadata may include the title, genre, prominent entertainers, length, source (such as a studio or broadcast network), and other items of information that describe aspects of the video. There also exist applications or programs that permit a user to define and customize metadata. For example, a user may wish to add a metadata field to describe a category or “mood” to be associated with one or more video files to customize or organize videos into personalized groupings for use at different types of situations, such as parties, traveling, or others.

### SUMMARY

To improve the consumer experience with electronic devices, there is a need in the art for an improved system and method for customizing media content, and particularly video content, by creating condensed portions of video content. The condensed portions may represent highlights constituting particularly enjoyable, entertaining, or interesting portions of the broader video content. In exemplary embodiments, the video files are “marked” or “flagged” about the portions of the video content to segment the highlight portion or portions within the media file. The marks or flags may be entered and incorporated as part of the metadata of the video file. A user's electronic device may then extract the marks or flags from the metadata, which causes a media player in the portable electronic device to play only the marked highlight portions. In addition, a user may share the highlights with others by transmitting the marked video files to others' electronic devices. Alternatively, the highlight creator may transmit only the metadata to another's electronic device, and the metadata marks may be extracted and applied in a time synchronized fashion to a video file stored on the other's device or streamed thereto.

Therefore, according to one aspect of the invention, an electronic device for creating highlights of a media file comprises a media player for playing media files wherein each media file has associated metadata, an input device, and a controller. The controller is configured to receive at least one input from the input device corresponding to a mark for a highlight portion of a media file, wherein the controller incorporates the mark for the highlight portion into the metadata associated with the media file to segment the highlight portion within the media file. The controller is further configured to extract the highlight mark from the metadata to cause the media player to play only the highlight portion of the media file.

According to one embodiment of the electronic device, the electronic device further comprises a storage device for storing at least one media file.

According to one embodiment of the electronic device, the controller is further configured to receive the media file from a source external to the electronic device.

According to one embodiment of the electronic device, the input device includes a microphone, and the controller is further configured to incorporate audio received by the microphone into the highlight portion of the media file.

According to one embodiment of the electronic device, the electronic device is a mobile telephone.

According to another aspect of the invention, a first system for creating highlights of a media file comprises a media player, a storage device for storing a plurality of media files wherein each of the media files has associated metadata, an input device, and a controller. The controller is configured to receive at least one input from the input device corresponding to a mark for a highlight portion of a media file, and the controller incorporates the mark for the highlight portion into the metadata associated with the media file to segment the highlight portion within the media file. The controller is further configured to extract the highlight mark from the metadata to cause the media player to play only the highlight portion of the media file.

According to one embodiment of the first system, the media player, input device, and controller are components of a same electronic device.

According to one embodiment of the first system, the input device includes a microphone, and the controller is further configured to incorporate audio received by the microphone into the highlight portion of the media file.

According to one embodiment of the first system, the electronic device is a mobile telephone.

According to one embodiment of the first system, the controller comprises a device controller within a user electronic device and a server controller within a network server external to the user electronic device. The server controller is configured to receive the input and incorporate the highlight marks into the metadata, and the device controller is configured to extract the highlight marks and cause the media player to play only the highlight portions of the media file.

According to one embodiment of the first system, the storage device is located within the network server, and the server controller is further configured to transmit the media file containing the marked metadata to the user electronic device.

According to one embodiment of the first system, the storage device is located within the network server, and the server controller is configured to transmit the marked metadata independent of the associated media file to the user electronic device.

According to one embodiment of the first system, the marked metadata includes time synchronization data to synchronize the marked metadata with a video content portion of a media file being played by the media player.

According to one embodiment of the first system, the input device includes a sensor and the input is a sensed change in an environmental condition.

According to one embodiment of the first system, the environmental condition is the level of audience noise.

According to one embodiment of the first system, the media files are video files.

According to another aspect of the invention, a second system for creating highlights of a media file comprises a plurality of user electronic devices each having an input device, a media player, a storage device for storing a plurality of media files wherein each of the media files has associated metadata, and a controller. The controller is configured to receive at least one input from an input device of at least one of the plurality of electronic devices, each input generating a mark for a highlight portion of a media file, and the controller incorporates marks for the highlight portion into the metadata associated with the media file to segment the highlight portion within the media file. The controller is further configured to extract the highlight markings from the metadata associated with the media file to cause the media player to play only the highlight portions of the media file.

According to one embodiment of the second system, the controller comprises a plurality of device controllers, one being within each the user electronic devices, and a network controller within a network device external to the user electronic devices. The network controller is configured to receive the at least one input and incorporate highlight marks into the metadata, and the device controllers are configured to extract the highlight marks and cause the media player to play only the highlight portions of the media file.

According to one embodiment of the second system, the network controller is further configured to incorporate marks based on a ranking system by which only marks corresponding to a threshold of user electronic device inputs are incorporated into the metadata.

According to one embodiment of the second system, the plurality of device controllers each are further configured to receive an input from the input device on the same user electronic device as the device controller, and to modify the metadata in accordance with the input.

According to one embodiment of the second system, the second system further comprising a wireless interface, wherein an input for marking a highlight portion of the media file is transmitted over the wireless interface for incorporation by the network controller into the metadata of a media file in the network device.

According to one embodiment of the second system, the marked metadata for the media file is transmitted from the network device over the wireless interface to at least one of the user electronic devices. The plurality of device controllers each are further configured to receive an input from the input device on the same user electronic device as the device controller, and to modify the metadata in accordance with the input.

According to one embodiment of the second system, the marked metadata is transmitted among each of the plurality of electronic devices over the wireless interface.

Another aspect of the invention is a method of playing a highlight portion of a media file comprising the steps of selecting a media file wherein the media file has associated metadata, identifying a highlight portion of the media file, marking the media file with at least one mark wherein the mark is associated with the identified highlight portion of the media file, incorporating the mark into the metadata associated with the media file to segment the identified highlight portion within the media file, extracting the highlight mark from the metadata, and playing only the highlight portion of the media file on an electronic device.

According to one embodiment of the method, a plurality of highlight portions are identified, and the marking, incorporating, and playing steps are performed as to each of the plurality of identified highlight portions.

According to one embodiment of the method, a plurality of media files are selected, and the identifying, marking, incorporating, and playing steps are performed as to each media file.

According to one embodiment of the method, the identifying and marking steps further comprise watching the media file, inputting a start point for the highlight portion of the media file, inputting an end point for the highlight portion of the media file, and incorporating the start point and end point into the metadata associated with the media file.

According to one embodiment of the method, the method further comprises storing the marked metadata in a file separate from a video content portion of the media file, and time synchronizing the marked metadata with the video content portion of the media file.

According to one embodiment of the method, the incorporating step further comprises adding commentary to the highlight portion of the media file.

According to one embodiment of the method, the selecting, identifying, marking, and incorporating steps are performed with a first electronic device. The method further comprises transmitting the marked metadata to a second electronic device, extracting the highlight mark from the metadata, and playing only the highlight portions of the media file on the second electronic device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic diagram of a mobile telephone as an exemplary electronic device for use in accordance with an embodiment of the present invention.

FIG. 2 is a schematic block diagram of operative portions of the mobile telephone of FIG. 1.

FIG. 3 is a schematic diagram that represents portions of a typical media file.

FIG. 4 is a flowchart depicting an exemplary method that may be used in accordance with an embodiment of the present invention.

FIG. 5 is a flowchart depicting another exemplary method that may be used in accordance with an embodiment of the present invention.

FIG. 6 is a schematic diagram of a communications system in which the mobile telephone of FIG. 1 may operate.

FIG. 7 is a schematic diagram of operative portions of an exemplary video highlights server that may be used in accordance with an embodiment of the present invention.

FIGS. 8 and 9 are schematic diagrams of exemplary menus viewed on a display of the mobile telephone of FIG. 1 for use in accordance with embodiments of the present invention.

FIG. 10 is a schematic diagram of a multi-user system in accordance with an embodiment of the present invention.

### DETAILED DESCRIPTION OF EMBODIMENTS

The present invention provides a system and method for customizing video content by permitting convenient creation of concatenated and condensed portions of broader video content. In this manner, viewers need not watch prolonged videos or programming. Rather, a viewer may watch customized highlights constituting the most entertaining and interesting portions of video content.

In exemplary embodiments, the broader video content may be marked or flagged about the portion of the video file to segment the video file into one or more condensed or highlight portions. A viewer may then select to play only the marked portions to provide a condensed viewing session of highlights. The marks may be incorporated as part of the metadata of the video file, and particularly may be stored as XML metadata fields. A user's electronic device may be configured to extract the marks or flags from the metadata. In accordance with the extracted marks, a media player of the electronic device may play only the highlight portions.

In certain embodiments, the highlights or condensed portions may be created by broadcasters or content providers. The marked video files may be stored on a network server, from which the video files may be downloaded or streamed to users' electronic devices. Alternatively or additionally, video files may be marked by individual users to generate customized highlights and condensed video content. Such customized video content may be shared with other users by transmitting the marked video files to others' electronic devices. Alternatively, the highlight creator may transmit only the marked metadata to others, and the receiving electronic device may extract and apply the marks, time synchronized, to a corresponding video file that may be stored or streamed thereto. Groups of users may edit the metadata highlight data, including by adding to the metadata additional highlight flags or marks. In this manner, groups may develop collective highlights to share with one another.

Embodiments of the present invention will now be described with reference to the drawings, wherein like reference numerals are used to refer to like elements throughout. It will be understood that the figures are not necessarily to scale.

The following description is made in the context of a conventional mobile telephone. It will be appreciated that the invention is not intended to be limited to the context of a mobile telephone and may relate to any type of appropriate electronic device, examples of which include a media player, a gaming device, or a desktop or laptop computer. For purposes of the description herein, the interchangeable terms “electronic equipment” and “electronic device” also may include portable radio communication equipment. The term “portable radio communication equipment,” which sometimes hereinafter is referred to as a “mobile radio terminal,” includes all equipment such as mobile telephones, pagers, communicators, electronic organizers, personal digital assistants (PDAs), smartphones, and any communication apparatus or the like.

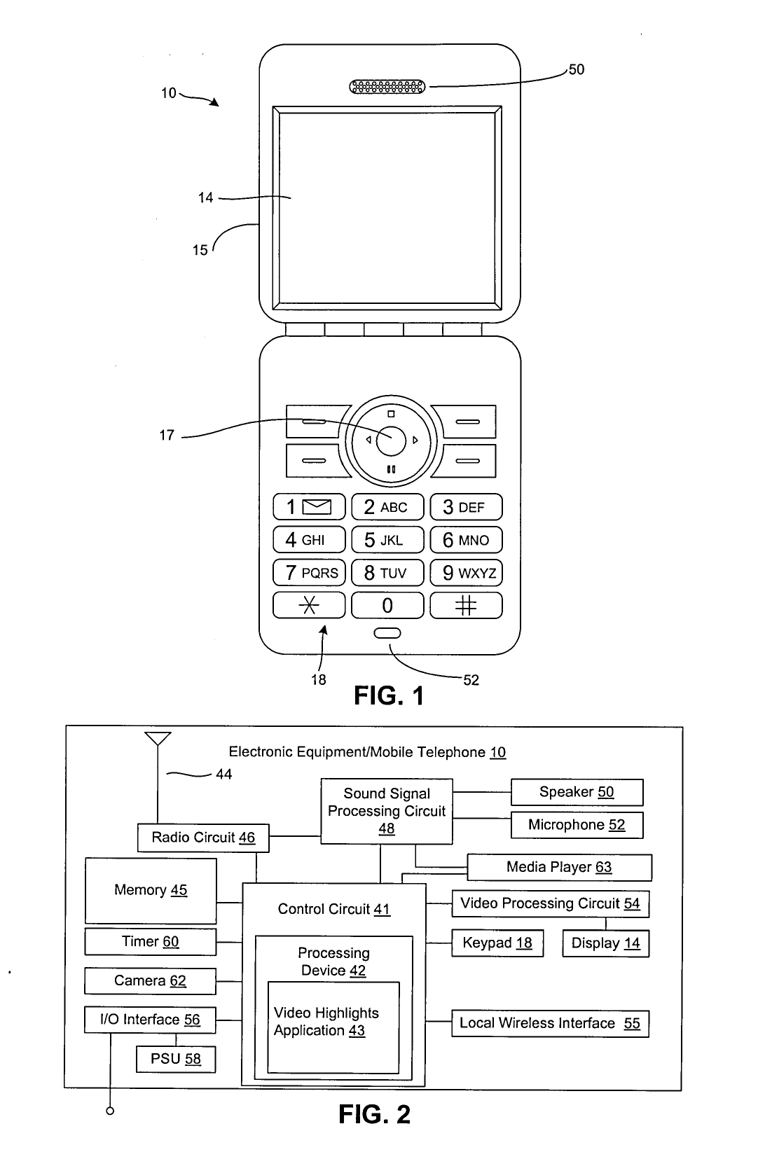

FIG. 1 depicts an exemplary mobile telephone 10. Mobile telephone 10 may be a clamshell phone with a flip-open cover 15 movable between an open and a closed position. In FIG. 1, the cover is shown in the open position. It will be appreciated that mobile telephone 10 may have other configurations, such as a “block” or “brick” configuration, or others.

FIG. 2 represents a functional block diagram of the mobile telephone 10. The mobile telephone 10 may include a video highlights application 43 for carrying out the features of the invention. It will be appreciated that the term “highlight”, as used herein, means any condensed portion of broader video content. For example, highlights may be conventional highlights of a sporting event, excerpts from a movie or television program, news excerpts, programming excluding commercials, or any other segment of broader video content. In addition, individual highlight portions may be grouped together in any sequence, and may span multiple files of video content. Application 43 may be embodied as executable program code that is resident in and executed by the mobile telephone 10.

Referring to FIGS. 1 and 2, mobile telephone 10 has a display 14 viewable when the clamshell telephone is in the open position. The display 14 displays information to a user regarding the various features and operating state of the mobile telephone 10, and displays visual content received by the mobile telephone 10 and/or retrieved from the memory 45. Also, the display 14 may be used as an electronic viewfinder for a camera assembly 62. The mobile telephone 10 also may include a media player 63 for playing audiovisual content stored in or received by the mobile telephone. The video portion of the content is displayed on the display 14.

A keypad 18 provides for a variety of user input operations. For example, keypad 18 typically includes alphanumeric keys for allowing entry of alphanumeric information such as telephone numbers, phone lists, contact information, notes, etc. In addition, keypad 18 typically includes special function keys 17 such as a “send” key for initiating or answering a call, and others. Special function keys 17 also may include keys for navigating and selecting items from a menu displayed on display 14. Some or all of the keys may be used in conjunction with the display as soft keys. Keys or key-like functionality also may be embodied as a touch screen associated with the display 14.

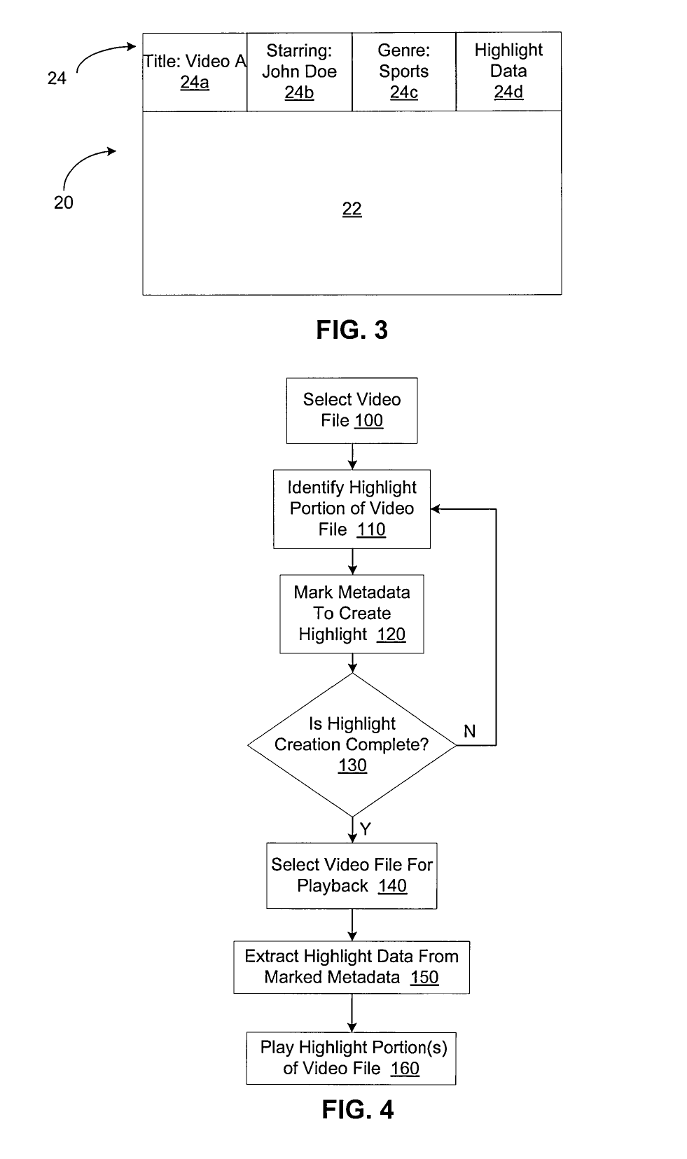

FIG. 3 is a schematic block diagram that represents the relevant portions of a typical media file 20. It will be appreciated that the media file may constitute any digital multimedia file that may include video moving images, still images, music, voice or other audio, or any combinations thereof. In exemplary embodiments, the media file is a video file 20. Video file 20 may be a single video, an excerpt of a video, or multiple videos grouped together. Video file 20 may include video content portion 22, which may be thought of as the substantive video itself. Video portion 22 may be coded in one of a variety of digital video formats such as MPEG, WMV, H.264, or other formats as are known in the art or may become available. Video 20 also may include associated metadata fields 24, which provide various items of information about the video. In the depicted example, the metadata includes four exemplary metadata fields, the first three being the video title (24a), stars (24b), and genre (24c). As is further described below, the metadata also may include highlight data (24d).

It will be appreciated that both the number and nature of the metadata fields may be varied. Some of the metadata, such as title and stars, may be unalterable and set at the time the video file is created. In addition, with an appropriate program or application as is known in the art, metadata fields may be defined by a user. For example, the user may wish to add a “mood” identifier as part of the metadata to associate the video with a particular mood, such as a party or relaxed mood for example. A user also may wish to add a category identifier as part of the metadata to group videos together, such as using metadata to create a “favorites” grouping of videos. Other examples of both automatic and user defined metadata fields may be employed. In addition, although the present invention is described with respect to videos as an exemplary embodiment, similar principles may be applied to metadata associated with other media content, such as music.

Referring again to FIG. 2, a plurality of video files 20 may be downloaded and stored within a memory 45 within the mobile telephone 10. Alternatively or additionally, video files may be streamed, either as recorded files or live broadcast feeds, to the mobile telephone from a server on a communications network. A media player 63 within the mobile telephone may be used to play video files stored in memory or streamed over a network.

FIG. 4 depicts an exemplary method of generating and accessing a highlight portion of video content from a single video file in accordance with an embodiment of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method begins at step 100, at which a video file may be selected for which highlights are desired. At step 110, a portion of the video file may be identified by the user or content provider as the desired highlight. At step 120, the video file may be marked or flagged to create the highlight. In preferred embodiments, the marks or flags are incorporated into the metadata of the video file to segment a highlight portion within the video file. At step 130, it is determined whether the creation of the highlight is complete. At this point, the creator of the highlights has the option to identify and mark additional portions of the video file to create and segment multiple highlight content. Once all highlights are identified and marked, the method may proceed.

As further described below, in certain embodiments the highlight portions may be identified and created by a content provider, such as a broadcaster or Internet service provider. Alternatively, individual users may identify and create the highlight content.

Once the creation of the highlights is complete, the method may proceed to step 140, at which the video file is selected for playback. At step 150, the highlight data is extracted from the marked metadata of the video file, and at step 160, the highlight portions of the video file corresponding to the marked metadata are played.

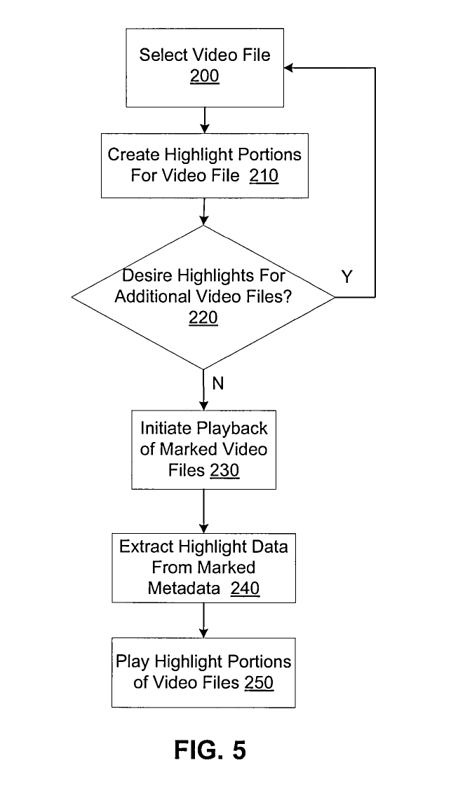

FIG. 4 represents the creation and playback of highlights in conjunction with a single video file. In other embodiments, highlight video may be created by combining highlights from more than one video file. FIG. 5 depicts an exemplary method of generating and accessing highlight portions of video content from multiple video files in accordance with an embodiment of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method begins at step 200, at which a video file may be selected for which highlights are desired. At step 210, highlight portions may be created with respect to the selected video file. In particular, the highlight portions may be created or segmented within the video file as described above in accordance with steps 110 through 130 of FIG. 4. At step 220, the highlight creator determines whether highlights from additional videos are desired. Again, the highlight creator may be a content provider or an individual user. If highlights from additional video files are desired, the method returns to step 200, at which the next video file is selected. Highlights for the second video file may be created and segmented as before at step 210, and so on. Once all desired highlights are created from the multiple video files, the method may proceed to step 230, at which playback of the marked video files is initiated. At step 240, the highlights data may be extracted from the marked metadata of the video files. It will be appreciated that in this embodiment, the metadata marks may include links among the various video files from which the highlights are created. At step 250, therefore, the highlights are played back in turn across the multiple video files.

As stated above, the highlights may be created pursuant to the methods of FIGS. 4 and 5 by a content provider, such as broadcaster, Internet or other network service provider, downloadable content provider, or others. In exemplary embodiments, individuals may access content from content providers using a home or portable user electronic device, such as the mobile telephone 10.

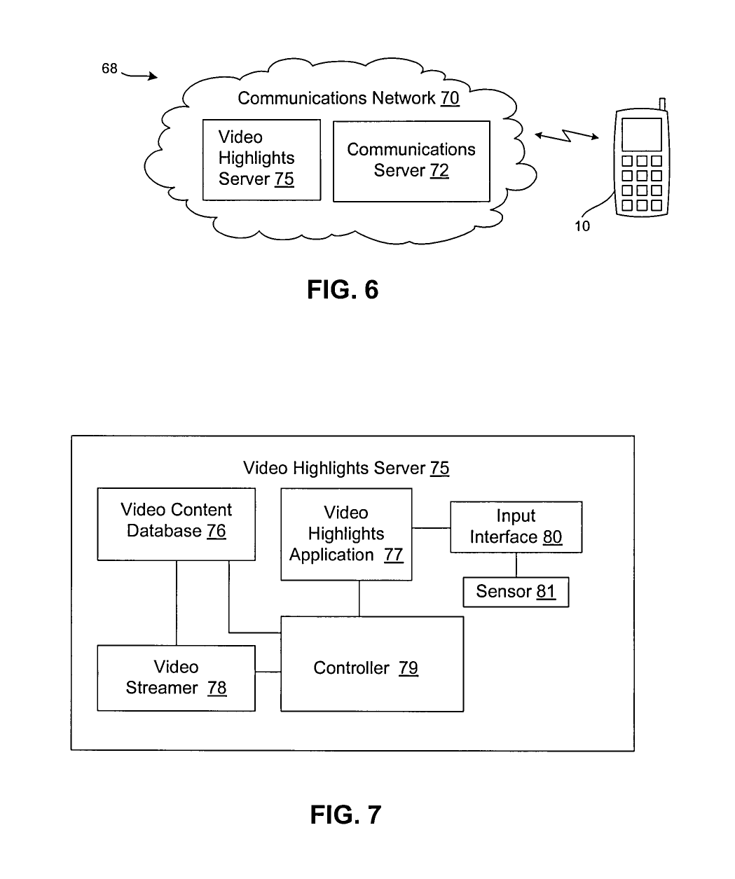

Referring to FIG. 6, for example, the mobile telephone 10 may be configured to operate as part of a communications system 68. The system 68 may include a communications network 70 having a communications server 72 (or servers) for managing calls placed by and destined to the mobile telephone 10, transmitting data to the mobile telephone 10 and carrying out any other support functions. The communication server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the communications server 72 may be configured as a typical computer system used to carry out server functions and may include a processor configured to execute software containing logical instructions that embody the functions of the communications server 72 and a memory to store such software.

Communications network 70 also may include a video highlights server 75 for use in accordance with embodiments of the present invention. FIG. 7 represents a functional block diagram of the components of an exemplary video highlights server 75. The video highlights server 75 may include a video content database 76 for storing a plurality of video files, such as movies, television programs, news and information content, and other video files. The video files stored in the video content database 76 may contain associated metadata as described above. The video highlights server also may include a video streamer 78 for streaming video content to a user. The streamed video content may originate from stored files in the database 76, and/or may comprise live broadcast feeds. The video highlights server also may include a controller 79 for carrying out and coordinating the various functions of the server.

Video highlights server 75 also may include a video highlights application 77, embodied as code executable by the controller 79. Via input interface 80, a content provider may identify condensed portions of video content to comprise the desired highlights. The inputs may be in a variety of forms. For example, a content provider may input a start point and an end point within a video file to segment a highlight. An operator may input highlight data points in real time or contemporaneously while the video is being created. For example, a sportscaster may mark a particular play for a highlight immediately upon completion of the play. Alternatively, an operator may input start and end points to segment highlights while watching a previously recorded video file. For content associated with a particular date and time, such as a sporting or news event, the highlight may be inputted by starting and ending time of day and date synchronized to the video file. Time data may be used in other ways. For example, if the known running time of a video file comprises an hour of content, an operator may select minutes 10-15 (or other) as being a highlight. Data size also may be used to create highlights by identifying a dataset within the media file to constitute the highlight portion, and inputting the dataset. For example, if a video file comprises 20 megabytes of data, an operator may select a dataset comprising megabytes 8-9 as being a highlight.

In alternative embodiments, highlight data may be generated automatically. For example, highlight start and end points may be generated by rising and falling levels of audience noise, as indicative of exciting or interesting portions of the content. In such embodiments, the input interface 80 may include an appropriate sensor or sensors 81 to sense an environmental condition to be associated with a desired highlight. In this embodiment, heuristics may be added to create highlights to include video portions encompassing a particular number of seconds around the event triggering the highlight. For example, if the highlight is created based on increased audience or crowd noise, the event triggering the increased noise likely occurred in the seconds prior to the change in noise level. The metadata of the video file, therefore, may be marked to incorporate portions of the video prior to the triggering event to more accurately define the highlight. It will be appreciated that these are but examples, and other features of the video content may be used to segment highlights.

As stated above, referring again to FIG. 7, an operator may input highlight data via the input interface 80 (or highlight data may be inputted via the interface 80 by an automatic mechanism with sensors 81). Video highlight application 77, as executed by the controller 79, may then incorporate the highlight data inputs into files within the video content database 76, and/or being streamed by the video streamer 78. In preferred embodiments, application 77 incorporates the highlight data as part of the metadata of the stored or streamed video files. A content provider may publish the highlighted content on a website or comparable network forum. The highlighted video files may be published as part of a free-access system or a subscription service.

A user who accesses the networked content may possess an electronic device having a cooperating video highlights application (for example, the video highlights application 43 depicted in FIG. 2). A user may enter a “highlights mode”, for example, through a conventional menu selection on an electronic device, such as a mobile telephone with a media player. When playing accessed content in a highlights mode, application 43 may extract the highlight data from the marked metadata of one or more video files, and in accordance with the marked metadata, only the highlight portions of a video file or files are played.

In one embodiment, a user may download or otherwise obtain the entire video file, including the marked metadata, from the content provider. Alternatively, the user may download or otherwise obtain only the marked metadata defining the highlights in a file independent of the underlying video content. The user's electronic device may extract the highlight data from the marked metadata and apply the marks to existing video content contained in a separate file stored in the electronic device, or obtained from another source. When the marked metadata is stored independently from the video content, the highlight data may include time synchronization information to match the highlight data to the corresponding video content. Extracting time synchronization data may proceed similarly to creating highlights based on time data. In one embodiment, if the video has a particular running time, the time synchronization information may correspond to the placement of the highlight within the running time. For example, if the running time of the video is sixty minutes, the time synchronization data may define the highlight as minutes 10-15 (or other). In another embodiment, if the video is a live or recorded event, the highlight data may be time synchronized with a particular time of day and date within the video file.

As seen in FIG. 2, the mobile telephone 10 may include a primary control circuit 41 that is configured to carry out overall control of the functions and operations of the mobile telephone 10. The control circuit 41 may include a processing device 42, such as a CPU, microcontroller or microprocessor. Among their functions, to implement the features of the present invention, the control circuit 41 and/or processing device 42 may comprise a controller that may execute program code embodied as the video highlights application 43. Similarly, as seen in FIG. 7, controller 79 may execute the program code embodied as video highlights application 77. It will be apparent to a person having ordinary skill in the art of computer programming, and specifically in application programming for cameras, mobile telephones, servers, or other electronic devices, how to program a mobile telephone or server to operate and carry out logical functions associated with applications 43 and/or 77. Accordingly, details as to specific programming code have been left out for the sake of brevity. Also, while the code may be executed by control circuits in accordance with exemplary embodiments, such controller functionality could also be carried out via dedicated hardware, firmware, software, or combinations thereof, without departing from the scope of the invention.

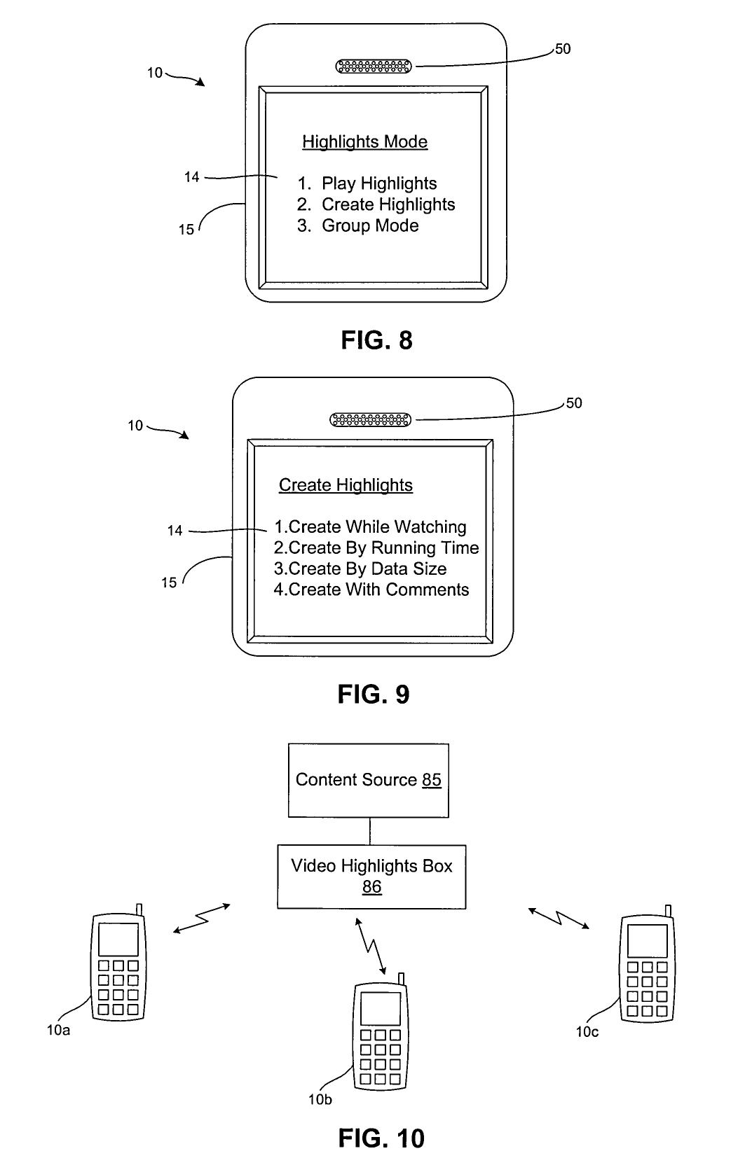

FIG. 8 represents an exemplary menu of options a mobile telephone user may access within a highlights mode. It will be appreciated that the menu options are examples, and other menu systems may be employed. As seen, one option is to select “Play Highlights”. By selecting this option, the playback of video content selected by the user may comprise playing only the highlight portions of the selected videos. For example, application 43 within the mobile telephone 10 may extract highlight marks from the metadata of a selected video file or files, and the corresponding highlights may be played by the media player 63.

Also shown in FIG. 8, a user may select a “Create Highlights” option within a highlights mode. This option may permit a user to create highlight marks or flags for selected videos. A user may do so initially, or modify the metadata as marked by other users. FIG. 9 depicts an exemplary sub-menu system for various options of creating highlights while in the “Create Highlights” mode. For example, one option is to create highlights while watching a selected video. For example, while watching a video, a user may press a function key 17 of keypad 18 (see FIG. 1) to input a start point for a highlight, and press function key 17 a second time to input an end point for a highlight. A user may then continue viewing the video file, entering additional highlight start and end points as desired. Among other uses, this feature may be employed to provide commercial-free viewing by segmenting the non-commercial portions of the video file as “highlights”. Once a single video has been viewed, a user may begin viewing another video file to string highlights across multiple videos. Application 43 may cause the inputs to be incorporated as marks or flags within the metadata of the selected video file for files. An additional input from another function key of keypad 18, such as a “send” or “end” key, may be used to end the particular highlight creation session. As other examples, similar to a content provider as described above, individual users may create highlights based on running time or data size. Such inputs also may be made with keypad 18 and then similarly incorporated into the metadata of the video file or files. Other methods of inputting highlight data or creating highlights may be employed.

As another example, FIG. 9 depicts a “Create With Comments” option in the selection menu. In this embodiment, a user may add voice comments or other audio to be added or dubbed into the highlights. Such audio may be recorded using a microphone 52 (see FIGS. 1 and 2), and incorporated into the highlights by application 43 in time synchronization with the video portions of the file. As described above, time synchronization in this context likewise may be based on video running time, or date and time of day.

Highlights also may be transmitted to other users via a wired or wireless interface as are known in the art. The other users may enjoy the highlight portions created by the first user, and also may have the option to modify the metadata to amend the highlights.

Referring again to FIG. 8, another menu option may include a “Group Mode” for creating group highlights. FIG. 10 depicts an exemplary system for creating group highlights. The system may include a content source 85, such as a television, computer, network server, other user, or other video source. The source may provide recorded video or live video content. A video highlights box 86 may be in communication with the video source 85. The video highlights box 86 may be a stand-alone box or incorporated into a conventional set top box, such as a Digital Video Recorder (DVR), satellite or cable TV box, or the like. The video highlights box 86 may operate similarly to the video highlights server 75 of previous embodiments in that it permits highlight access and creation by multiple users. In particular, video highlights box 86 may include an interface for receiving inputs of highlight data, and an application comparable to application 77 and/or 43 for incorporating the inputted highlight data into the metadata of selected video files. The video highlights box also may include a memory or database for storing marked video files, or the created highlights as separate files.

In the example, of FIG. 10, three mobile telephones 10a, 10b, and 10c are participating in group highlights creation. It will be appreciated that the precise number of participants may vary. In preferred embodiments, as shown in the figure by the jagged arrows, the mobile telephones are in wireless communication with the video highlights box 86 via a wireless interface. The wireless interface may be a Bluetooth, RF, infrared, or other short range wireless interface as are known in the art. Each user may select, such as by using the telephone keypad, portions of a video or videos to become highlights. In one embodiment, the video highlights box may incorporate all inputs from all users into the highlight data. In alternative embodiments, the video highlights box may apply a “voting” or “rating” type algorithm, by which inputs are included only after a certain threshold of inputs is received from the various users, for example. Furthermore, in a group mode, the media player may be associated within a common viewing monitor, such as a television, shared computer monitor, and the like, rather than playing the video on each individual's electronic device.

In another embodiment, group highlight data may be generated automatically and across multiple applications. For example, multiple users may be watching the same video content while also engaging in an instant messaging (IM) or network “chat” session. Highlights may be generated automatically by an increase in the level of IM activity. In some sense, this embodiment may be analogous to the audience or “crowd noise” embodiment described above. The increased IM activity may be considered indicative of increased interest or entertainment in the portion of the video being viewed at that time. Furthermore, similar to the audience noise embodiment, the highlight data may be defined to encompass a portion of the video preceding the increased IM activity to more accurately define the highlight.

In addition, as stated above, highlights may be shared among users. Creators of highlights may transmit entire video files containing marked metadata to others. Alternatively, a creator may transmit only the marked metadata to be applied to video files stored by a receiving user within the receiver's electronic device, or streamed thereto. In this manner, copyrights may more easily be protected because each user would have his or her own copy of the underlying video files. In addition, receiving users may add to the highlight data, thereby providing another way by which group highlights may be created and shared. The highlights may be shared over a wireless interface comparable to that depicted in FIG. 10. When only the marked metadata is shared, the highlight data may also include time synchronization information, as described above.

Referring again to FIG. 2, additional features of the mobile telephone 10 will now be described. For the sake of brevity, generally conventional features of the mobile telephone 10 will not be described in great detail herein. The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages (e.g., colloquially referred to by some as “an SMS,” which stands for short message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 45, executing applications to allow user interaction with data, displaying video and/or image content associated with the data, outputting audio sounds associated with the data and so forth.

The mobile telephone 10 may include an antenna 44 coupled to a radio circuit 46. The radio circuit 46 includes a radio frequency transmitter and receiver for transmitting and receiving signals via the antenna 44 as is conventional. The mobile telephone 10 further includes a sound signal processing circuit 48 for processing audio signals transmitted by and received from the radio circuit 46. Coupled to the sound processing circuit 48 are a speaker 50 and microphone 52 that enable a user to listen and speak via the mobile telephone 10 as is conventional.

The display 14 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 45, derived from an incoming video data stream received by the radio circuit 48 or obtained by any other suitable method.

The mobile telephone 10 also may include a local wireless interface 55, such as an infrared transceiver and/or an RF adaptor (e.g., a Bluetooth adapter), for establishing communication with an accessory, another mobile radio terminal, a computer or another device. The local wireless interface 55 also may be used in connection with group highlights creation as described above with respect to FIG. 10.

The mobile telephone 10 also may include an I/O interface 56 that permits connection to a variety of I/O conventional I/O devices. One such device is a power charger that can be used to charge an internal power supply unit (PSU) 58.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device for creating highlights of a media file comprising:
a media player for playing media files, wherein each media file has associated metadata;
an input device; and
a controller configured to receive at least one input from the input device corresponding to a mark for a highlight portion of a media file, wherein the controller incorporates the mark for the highlight portion into the metadata associated with the media file to segment the highlight portion within the media file; and
wherein the controller is further configured to extract the highlight mark from the metadata to cause the media player to play only the highlight portion of the media file.

2. The electronic device according to claim 1 further comprising a storage device for storing at least one media file.

3. The electronic device according to claim 1, wherein the controller is further configured to receive the media file from a source external to the electronic device.

4. The electronic device according to claim 1, wherein the input device includes a microphone, and the controller is further configured to incorporate audio received by the microphone into the highlight portion of the media file.

5. The electronic device according to claim 1, wherein the electronic device is a mobile telephone.

6. A system for creating highlights of a media file comprising:
a media player;
a storage device for storing a plurality of media files, wherein each of the media files has associated metadata;
an input device; and
a controller configured to receive at least one input from the input device corresponding to a mark for a highlight portion of a media file, wherein the controller incorporates the mark for the highlight portion into the metadata associated with the media file to segment the highlight portion within the media file; and
wherein the controller is further configured to extract the highlight mark from the metadata to cause the media player to play only the highlight portion of the media file.

7. The system according to claim 6, wherein the media player, input device, and controller are components of a same electronic device.

8. The system according to claim 7, wherein the input device includes a microphone, and the controller is further configured to incorporate audio received by the microphone into the highlight portion of the media file.

9. The system according to claim 7, wherein the electronic device is a mobile telephone.

10. The system according to claim 6, wherein the controller comprises a device controller within a user electronic device and a server controller within a network server external to the user electronic device, wherein the server controller is configured to receive the input and incorporate the highlight marks into the metadata, and the device controller is configured to extract the highlight marks and cause the media player to play only the highlight portions of the media file.

11. The system according to claim 10, wherein the storage device is located within the network server, and the server controller is further configured to transmit the media file containing the marked metadata to the user electronic device.

12. The system according to claim 10, wherein the storage device is located within the network server, and the server controller is configured to transmit the marked metadata independent of the associated media file to the user electronic device.

13. The system according to claim 12, wherein the marked metadata includes time synchronization data to synchronize the marked metadata with a video content portion of a media file being played by the media player.

14. The system according to claim 10, wherein the input device includes a sensor and the input is a sensed change in an environmental condition.

15. The system according to claim 14, wherein the environmental condition is the level of audience noise.

16. The system according to claim 6, wherein the media files are video files.

17. A system for creating highlights of a media file comprising:
a plurality of user electronic devices each having an input device;
a media player;
a storage device for storing a plurality of media files, wherein each of the media files has associated metadata; and
a controller, wherein the controller is configured to receive at least one input from an input device of at least one of the plurality of electronic devices, each input generating a mark for a highlight portion of a media file, and wherein the controller incorporates marks for the highlight portion into the metadata associated with the media file to segment the highlight portion within the media file; and
wherein the controller is further configured to extract the highlight markings from the metadata associated with the media file to cause the media player to play only the highlight portions of the media file.

18. The system according to claim 17, wherein the controller comprises:
a plurality of device controllers, one being within each the user electronic devices; and
a network controller within a network device external to the user electronic devices;
wherein the network controller is configured to receive the at least one input and incorporate highlight marks into the metadata, and the device controllers are configured to extract the highlight marks and cause the media player to play only the highlight portions of the media file.

19. The system according to claim 18, wherein the network controller is further configured to incorporate marks based on a ranking system by which only marks corresponding to a threshold of user electronic device inputs are incorporated into the metadata.

20. The system according to claim 18, wherein the plurality of device controllers each are further configured to receive an input from the input device on the same user electronic device as the device controller, and to modify the metadata in accordance with the input.

21. The system according to claim 18 further comprising a wireless interface, wherein an input for marking a highlight portion of the media file is transmitted over the wireless interface for incorporation by the network controller into the metadata of a media file in the network device.

22. The system according to claim 21, wherein the marked metadata for the media file is transmitted from the network device over the wireless interface to at least one of the user electronic devices; and
wherein the plurality of device controllers each are further configured to receive an input from the input device on the same user electronic device as the device controller, and to modify the metadata in accordance with the input.

23. The system according to claim 22, wherein the marked metadata is transmitted among each of the plurality of electronic devices over the wireless interface.

24. A method of playing a highlight portion of a media file comprising the steps of:
selecting a media file, wherein the media file has associated metadata;
identifying a highlight portion of the media file;
marking the media file with at least one mark, wherein the mark is associated with the identified highlight portion of the media file;
incorporating the mark into the metadata associated with the media file to segment the identified highlight portion within the media file;
extracting the highlight mark from the metadata; and
playing only the highlight portion of the media file on an electronic device.

25. The method according to claim 24, wherein a plurality of highlight portions are identified, and the marking, incorporating, and playing steps are performed as to each of the plurality of identified highlight portions.

26. The method according to claim 24, wherein a plurality of media files are selected, and the identifying, marking, incorporating, and playing steps are performed as to each media file.

27. The method according to claim 24, wherein the identifying and marking steps further comprise:
watching the media file;
inputting a start point for the highlight portion of the media file;
inputting an end point for the highlight portion of the media file; and
incorporating the start point and end point into the metadata associated with the media file.

28. The method according to claim 24 further comprising:
storing the marked metadata in a file separate from a video content portion of the media file; and
time synchronizing the marked metadata with the video content portion of the media file.

29. The method according to claim 24, wherein the incorporating step further comprises adding commentary to the highlight portion of the media file.

30. The method according to claim 24, wherein the selecting, identifying, marking, and incorporating steps are performed with a first electronic device, and further comprising:
transmitting the marked metadata to a second electronic device;
extracting the highlight mark from the metadata; and
playing only the highlight portions of the media file on the second electronic device.
